(19) United States
(12) Patent Application Publication
(10) Pub. No.: US 2005/0155798 A1
(43) Pub. Date: Jul. 21, 2005

(54) Vehicle having auxiliary driving device

(76) Inventors: Hui Lung Chang, Taichung (TW); Chiao Ching Chang, Taichung (TW)

Correspondence Address: Hui Lung Chang, P.O. Box 63-298, Taichung, 406, TW

(21) Appl. No.: 10/764,306

(22) Filed: Jan. 20, 2004

(51) Int. Cl. B62D 55/00

(52) U.S. Cl. 180/9.32

(57) ABSTRACT

A vehicle includes a chassis, a primary driving device attached to the chassis for moving the vehicle on road, and a motivating device attached to the chassis for motivating the primary driving device to move the vehicle on the road. An auxiliary driving device is further attached to the chassis, and includes a height greater than that of the primary driving device for help moving the vehicle on the road when the primary driving device is stuck in mud of the rod. Each of the primary and the auxiliary driving devices includes a number of wheels and two caterpillar treads selectively engaged with the wheels for moving the vehicle on the road.

### BACKGROUND OF THE INVENTION

1. Field of the Invention

The present invention relates to a vehicle, and more particularly to a vehicle having an auxiliary driving device in addition to a primary driving device.

2. Description of the Prior Art

Typical vehicles comprise four or more wheels for engaging with the ground, and for allowing the vehicles to move on the road. However, when the wheels of the vehicle are sunk or stuck in the mud of the road, no other auxiliary driving devices may be provided to help to disengage the wheels from the mud of the road.

Similarly, for the typical caterpillar tractors or the like, one or more, such as two caterpillar treads are provided for engaging with the ground, and for moving the typical caterpillar tractors or the like on the road. However, similarly, when the caterpillar treads of the typical caterpillar tractors are sunk or stuck in the mud of the road, no other auxiliary driving devices may be provided to help to disengage the caterpillar treads from the mud of the road.

Normally, when the wheels of the typical vehicles or when the caterpillar treads of the typical caterpillar tractors are sunk or stuck in the mud of the road, a number of persons are required to be called together and to find and pour much stones, soil, tree trunks, or the like onto the mud, in order to help the typical vehicles or the typical caterpillar tractors out of the mud of the road.

Some times, the other vehicles are further required to couple to and to pull the typical vehicles or the typical caterpillar tractors out of the mud of the road.

The present invention has arisen to mitigate and/or obviate the afore-described disadvantages of the conventional vehicles.

### SUMMARY OF THE INVENTION

The primary objective of the present invention is to provide a vehicle including an auxiliary driving device in addition to a primary driving device, to help driving the vehicle when the primary driving device is unusable or is not good enough to drive the vehicle.

In accordance with one aspect of the invention, there is provided a vehicle comprising a chassis, a primary driving device attached to the chassis for moving the vehicle on road, a motivating device for motivating the primary driving device to move the vehicle on the road, and an auxiliary driving device attached to the chassis, and including a height greater than that of the primary driving device for help moving the vehicle on the road when the primary driving device is stuck in mud of the rod.

The primary driving device includes at least four wheels attached to the chassis for moving the vehicle on the road. The primary driving device further includes two caterpillar treads engaged with the wheels for moving the vehicle on the road.

The motivating device includes a front axle attached to the chassis, and two gears attached to the front axle and engaged with the caterpillar treads. The motivating device further includes a motor coupled to the front axle, to drive the caterpillar treads via the front axle and the gears.

The motivating device further includes a reduction gearing attached to the front axle, and coupled to the motor, to allow the motor to drive the front axle via the reduction gearing. Two rear axles may further be provided and attached to the chassis, and two gears attached to the rear axles respectively and engaged with the caterpillar treads.

The auxiliary driving device includes at least four wheels attached to the chassis for moving the vehicle on the road when the primary driving device is stuck in mud of the rod. The auxiliary driving device includes two caterpillar treads engaged with the wheels. Two gears may further be provided and attached to the rear axles respectively and engaged with the caterpillar treads of the auxiliary driving device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a vehicle in accordance with the present invention;

FIG. 2 is a partial exploded view of the vehicle;

FIG. 3 is a partial cross sectional view taken along lines 3-3 of FIG. 1;

FIG. 4 is a partial cross sectional view taken along lines 4-4 of FIG. 1; and

FIG. 5 is a side schematic view illustrating the operation of the vehicle.

### DETAILED DESCRIPTION OF THE PREFERRED EMBODIMENT

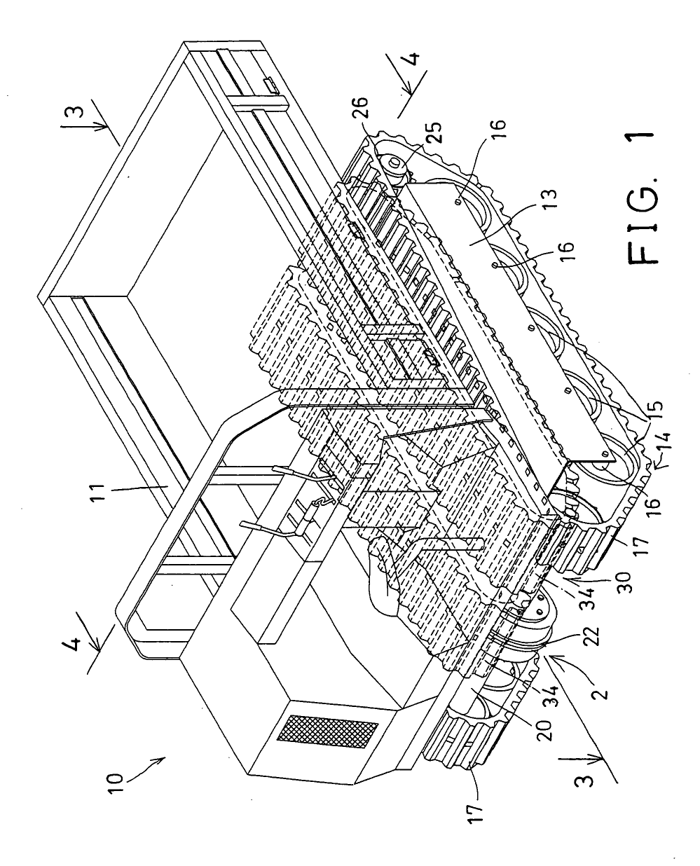

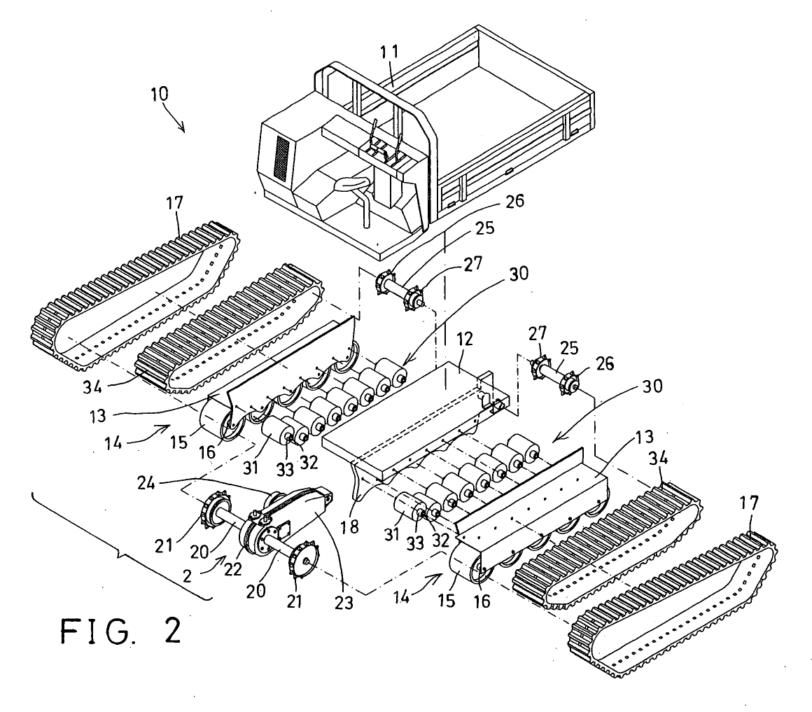

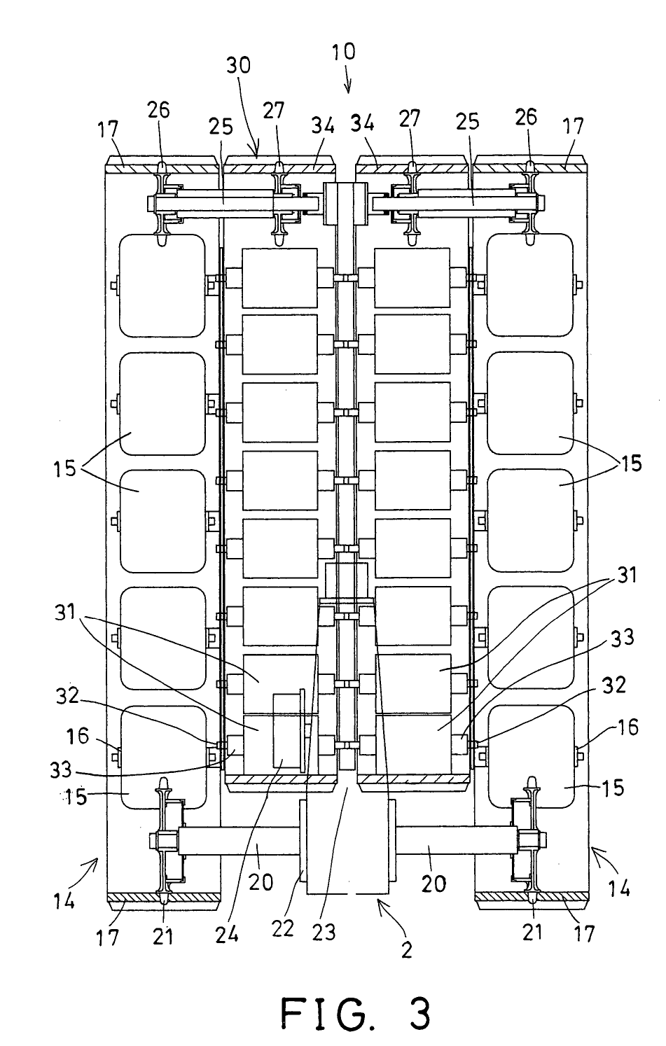

Referring to the drawings, and initially to FIGS. 1-4, a vehicle 10 in accordance with the present invention comprises a vehicle body 11, and a chassis 12 attached to the bottom of the vehicle body 11. The chassis 12 may include two frames 13 attached to the sides thereof for supporting a primary driving device 14.

For example, the primary driving device 14 includes two or more wheels 15, such as two rows of wheels 15 rotatably attached to the chassis 12 with shafts 16. For example, the shafts 16 may be rotatably secured in the frames 13 respectively, to support the wheels 15, which may be used to move the vehicle 10.

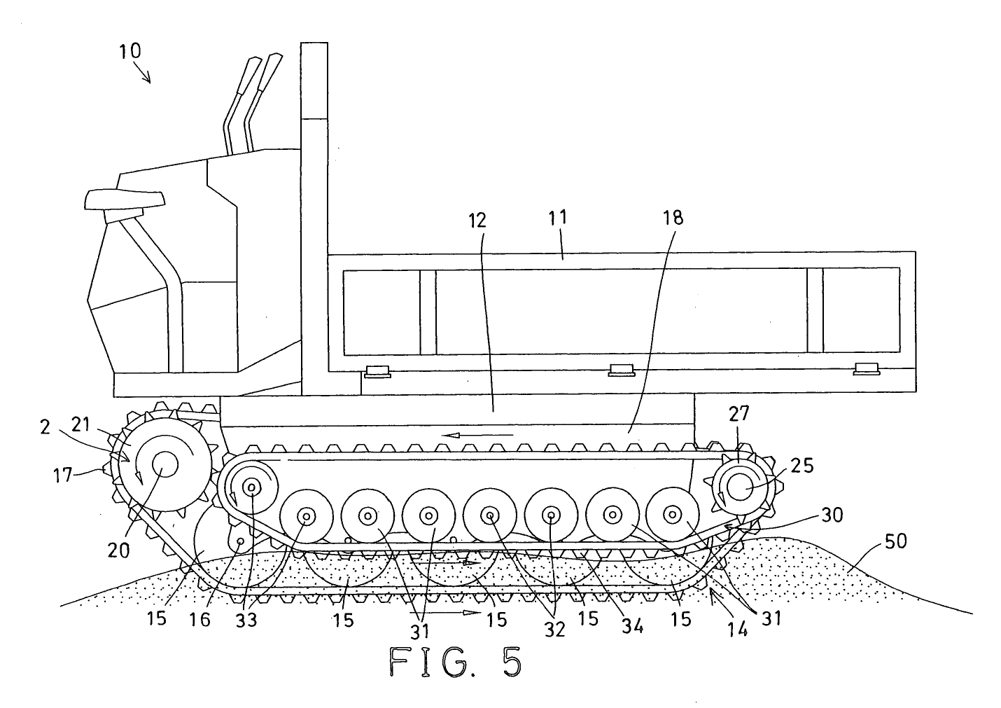

The primary driving device 14 further includes one or more, such as two caterpillar treads 17 engaged with or engaged onto the wheels 15 and/or the frames 13, for engaging with the ground. As shown in FIGS. 1 and 5, the wheels 15 may be engaged with the caterpillar treads 17 for moving the vehicle 10 on the road.

A motivating device 2 includes a front axle 20 attached to the chassis 12 of the vehicle 10, and one or more, such as two sprockets or gears 21 attached thereon and engaged with the caterpillar treads 17, for driving or rotating the caterpillar treads 17 around the wheels 15 and/or the frames 13.

The motivating device 2 includes a reduction gearing 22 attached to or coupled to the front axle 20, and attached to or coupled to the chassis 12 with a casing 23. For example, the casing 23 may be attached to a downwardly extended partition 18 of the chassis 12. A motor 24 is attached to the casing 23 and coupled to the reduction gearing 22, to drive the gears 21 to move the caterpillar treads 17, and thus to move the vehicle 10.

The vehicle 10 further includes one or more, such as two rear axles 25 rotatably attached to the rear portion of the chassis 12 of the vehicle 10, and one or more, such as two sprockets or gears 26 attached thereon and engaged with the caterpillar treads 17, for being driven or rotated by the caterpillar treads 17, and for supporting the caterpillar treads 17 in suitable configuration or tension. The rear axles 25 may each further include a further sprocket or gear 27 attached thereon.

An auxiliary driving device 30 may further be provided and attached to the chassis 12 to facilitate the moving of the vehicle 10. The auxiliary driving device 30 includes two or more wheels 31, such as two rows of wheels 31 rotatably attached to the chassis 12 with shafts 32 and/or bearings 33. For example, the shafts 32 may be rotatably secured to the partition 18 of the chassis 12, or stably secured between the frames 13 and the partition 18 of the chassis 12 respectively, to stably support the wheels 32.

The auxiliary driving device 30 further includes one or more, such as two caterpillar treads 34 engaged with or engaged onto the wheels 31, for engaging with the ground (FIG. 5). As shown in FIG. 5, the wheels 31 may be engaged with the caterpillar treads 34 for moving the vehicle 10 on the road, when required. The gears 27 are engaged with the caterpillar treads 34 respectively, for allowing the caterpillar treads 34 to be driven by the motor 24 via the rear axles 25.

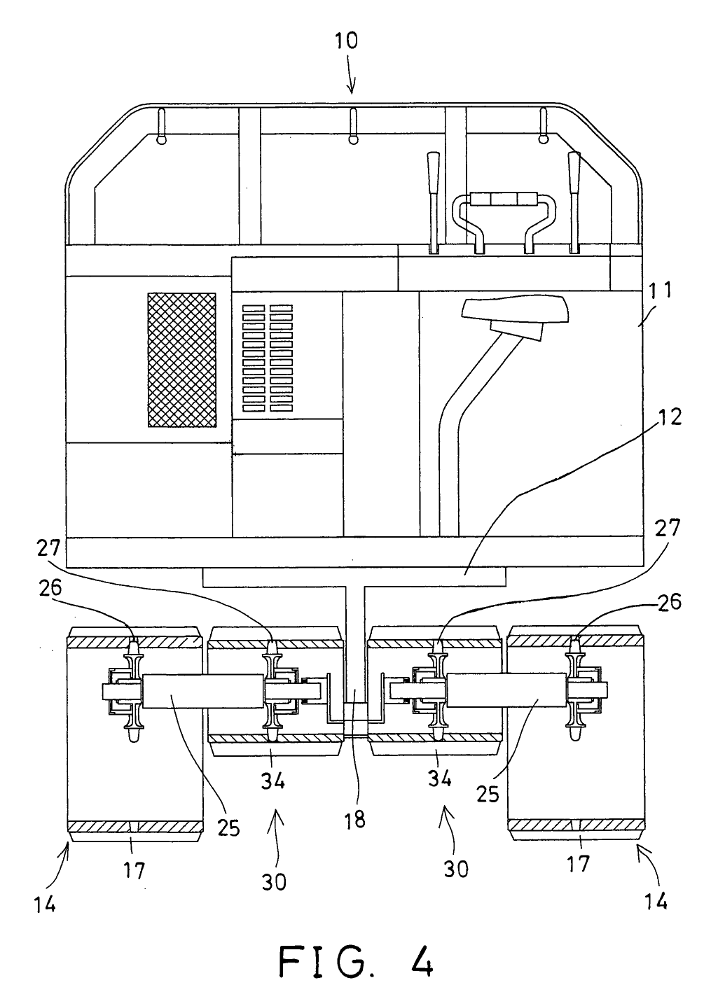

As best shown in FIGS. 4 and 5, the wheels 31 and/or the caterpillar treads 34 of the auxiliary driving device 30 include a height greater than the wheels 15 and/or the caterpillar treads 17 of the primary driving device 14, for allowing the wheels 31 and/or the caterpillar treads 34 of the auxiliary driving device 30 to be engaged with the mud 50 of the road when the wheels 15 and/or the caterpillar treads 17 of the primary driving device 14 are sunk or stuck in the mud 50 of the road.

In operation, as shown in FIG. 5, when the wheels 15 and/or the caterpillar treads 17 of the primary driving device 14 are sunk or stuck in the mud 50 of the road, the auxiliary driving device 30 may be engaged with the road, to help or to facilitate the moving of the vehicle 10 on the road.

Accordingly, the vehicle in accordance with the present invention includes an auxiliary driving device in addition to a primary driving device, to help driving the vehicle when the primary driving device is unusable or is not good enough to drive the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A vehicle comprising:
a chassis,
a primary driving device attached to said chassis for moving said vehicle on road,
means for motivating said primary driving device to move said vehicle on the road, and
an auxiliary driving device attached to said chassis, and including a height greater than that of said primary driving device for help moving said vehicle on the road when said primary driving device is stuck in mud of the rod.

2. The vehicle as claimed in claim 1, wherein said primary driving device includes at least four wheels attached to said chassis for moving said vehicle on the road.

3. The vehicle as claimed in claim 2, wherein said primary driving device includes two caterpillar treads engaged with said at least four wheels for moving said vehicle on the road.

4. The vehicle as claimed in claim 3, wherein said motivating means includes a front axle attached to said chassis, and two gears attached to said front axle and engaged with said caterpillar treads.

5. The vehicle as claimed in claim 4, wherein said motivating means includes a motor coupled to said front axle, to drive said caterpillar treads via said front axle and said gears.

6. The vehicle as claimed in claim 5, wherein said motivating means includes a reduction gearing attached to said front axle, and coupled to said motor, to allow said motor to drive said front axle via said reduction gearing.

7. The vehicle as claimed in claim 3 further comprising two rear axles attached to said chassis, and two gears attached to said rear axles respectively and engaged with said caterpillar treads.

8. The vehicle as claimed in claim 1, wherein said auxiliary driving device includes at least four wheels attached to said chassis for moving said vehicle on the road when said primary driving device is stuck in mud of the rod.

9. The vehicle as claimed in claim 8, wherein said auxiliary driving device includes two caterpillar treads engaged with said at least four wheels.

10. The vehicle as claimed in claim 9 further comprising two rear axles attached to said chassis, and two gears attached to said rear axles respectively and engaged with said caterpillar treads.
